(19) United States
(12) Patent Application Publication
(10) Pub. No.: US 2002/0170201 A1
(43) Pub. Date: Nov. 21, 2002

(54) Antler scoring system

(76) Inventors: Blair S. Trout, Newbrook (CA); Scott A. Wolff, Golden Valley, ND (US)

Correspondence Address: Michael S. Neustel, Suite No.4, 2534 South University Drive, Fargo, ND, 58103, US

(21) Appl. No.: 09/858,311

(22) Filed: May 15, 2001

(51) Int. Cl. G01B 3/12; G01B 3/10

(52) U.S. Cl. 33/773; 33/775; 33/759; 33/760

(57) ABSTRACT

An antler scoring system for enabling efficient and accurate measurement of antlers. The antler scoring system includes a housing, a wheel member rotatably attached to the housing for measuring lengths and diameters, a central processing unit within the housing in communication with the wheel member for calculating measurements and a final score, a keypad for entering in manual measurements, and a ruler extendably positioned within. The user first utilizes the wheel member to measure the length of the main beams, each tine length, and the circumference between each tine. The user then utilizes the ruler to measure the inside spread between the main beams which is entered into the keypad. The central processing unit combines the total measurements to generate a final score based upon one or more antler scoring systems such as BOONE & CROCKET, SAFARI CLUB INTERNATIONAL, and BUCKMASTERS TROPHY RECORDS.

### BACKGROUND OF THE INVENTION

1. Field of the Invention

The present invention relates generally to antler scoring systems and more specifically it relates to an antler scoring system for enabling efficient and accurate measurement of antlers.

2. Description of the Prior Art

Antler measuring systems have been in use for years. The three most commonly utilized antler measuring systems are BOONE & CROCKET, SAFARI CLUB INTERNATIONAL, and BUCKMASTERS TROPHY RECORDS. All of these antler scoring systems provide a “score sheet” for an “official measurer” to record various measurements such as the number of points on the left and right antlers, the tip-to-tip spread, the greatest spread between the antlers, the inside spread of the main beams, total lengths of abnormal points, length of main beam, length of each individual point, circumference at smallest place between burr and first point, circumference at smallest place between each of the points and various other required measurements. These calculations are combined into a formula to generate a “final score” that is utilized to provide the overall score for the antlers. The formula may be comprised of various equations that provide a consistent scoring system.

The main problem with conventional antler scoring systems is that they require an individual to first measure with a taper measure or similar instrument then record the measurement in writing upon the score sheet which is time consuming, tedious and prone to mistakes or misunderstandings. A further problem with conventional antler scoring systems is that they are not convenient to utilize within the field immediately after an animal has been killed. A further problem with conventional antler scoring systems is that they are not easily utilized by farmers to calculate a score of an animal within a chute without causing prolonged stress to the animal.

While these systems may be suitable for the particular purpose to which they address, they are not as suitable for enabling efficient and accurate measurement of antlers. Conventional antler measuring systems are time consuming and difficult to utilize.

In these respects, the antler scoring system according to the present invention substantially departs from the conventional concepts and designs of the prior art, and in so doing provides an apparatus primarily developed for the purpose of enabling efficient and accurate measurement of antlers.

### SUMMARY OF THE INVENTION

In view of the foregoing disadvantages inherent in the known types of antler measuring systems now present in the prior art, the present invention provides a new antler scoring system construction wherein the same can be utilized for enabling efficient and accurate measurement of antlers.

The general purpose of the present invention, which will be described subsequently in greater detail, is to provide a new antler scoring system that has many of the advantages of the antler measuring systems mentioned heretofore and many novel features that result in a new antler scoring system which is not anticipated, rendered obvious, suggested, or even implied by any of the prior art antler measuring systems, either alone or in any combination thereof.

To attain this, the present invention generally comprises a housing, a wheel member rotatably attached to the housing for measuring lengths and diameters, a central processing unit within the housing in communication with the wheel member for calculating measurements and a final score, a keypad for entering in manual measurements, and a ruler extendably positioned within. The user first utilizes the wheel member to measure the length of the main beams, each tine length, and the circumference between each tine. The user then utilizes the ruler to measure the inside spread between the main beams which is entered into the keypad. The central processing unit combines the total measurements to generate a final score based upon one or more antler scoring systems such as BOONE & CROCKET, SAFARI CLUB INTERNATIONAL, and BUCKMASTERS TROPHY RECORDS.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an antler scoring system that will overcome the shortcomings of the prior art devices.

A second object is to provide an antler scoring system for enabling efficient and accurate measurement of antlers.

Another object is to provide an antler scoring system that may be utilized in various field conditions.

An additional object is to provide an antler scoring system that reduces the stress an animal incurs while their antlers are being measured.

A further object is to provide an antler scoring system that is comprised of a compact structure that may be easily transported during a hunt.

Another object is to provide an antler scoring system that may score the antlers of an animal utilizing one or more of the conventional scoring methods such as BOONE & CROCKET, SAFARI CLUB INTERNATIONAL, and BUCKMASTERS TROPHY RECORDS.

A further object is to provide an antler scoring system that reduces human error in calculating a final score.

Another object is to provide an antler scoring system that simplifies the process for calculating the score for antlers.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention illustrating the display.

FIG. 3 is a top view of the present invention.

FIG. 4 is an upper perspective view of the present invention being utilized to measure the length of the main beam of an antler.

### DESCRIPTION OF THE PREFERRED EMBODIMENT

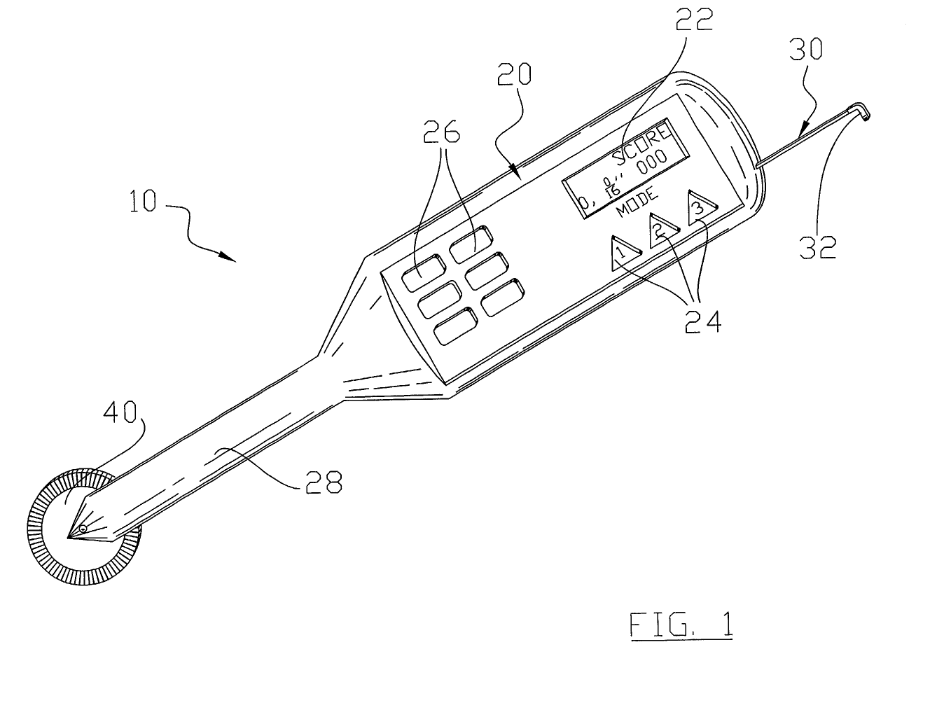

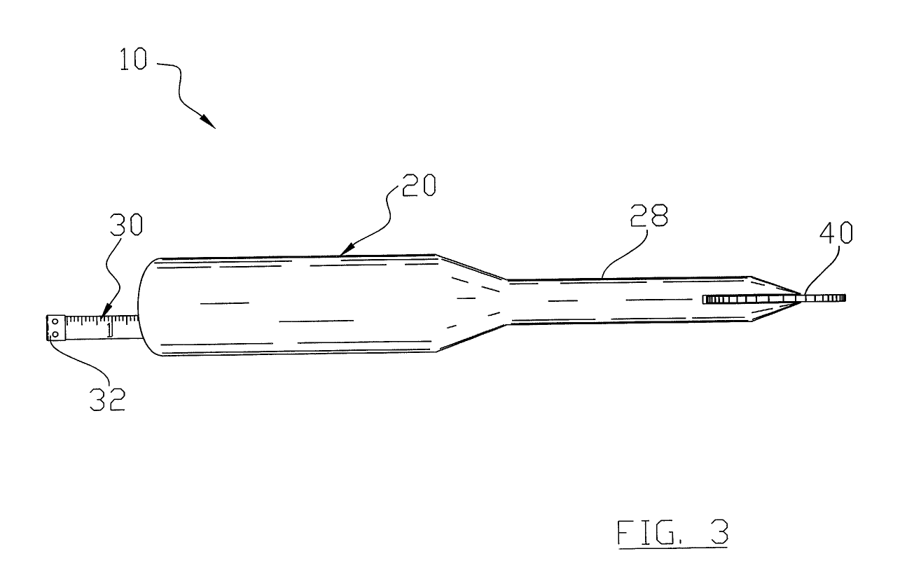

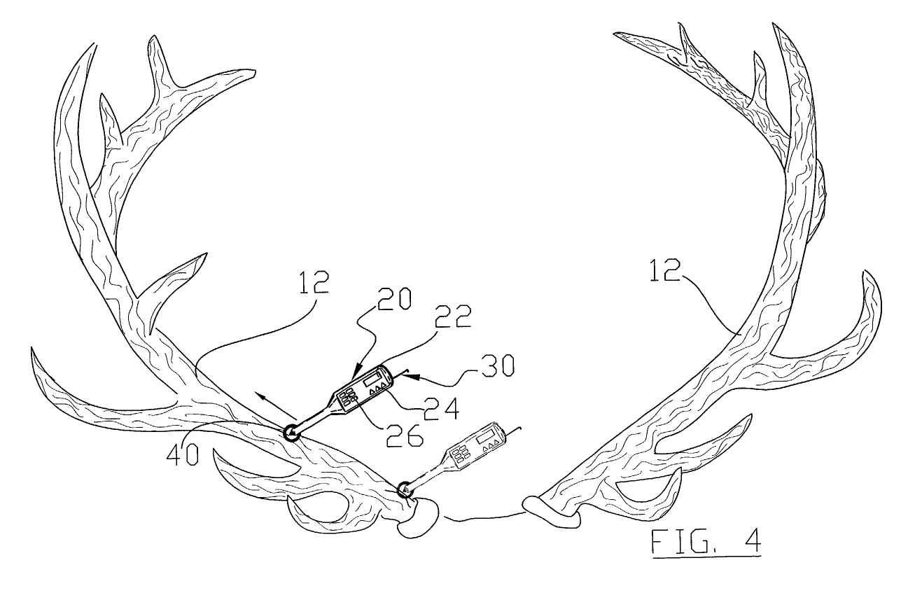

Turning now descriptively to the drawings, in which similar reference characters denote similar elements throughout the several views, FIGS. 1 through 4 illustrate an antler scoring system 10, which comprises a housing 20, a wheel member 40 rotatably attached to the housing 20 for measuring lengths and diameters, a central processing unit within the housing 20 in communication with the wheel member 40 for calculating measurements and a final score, a keypad 26 for entering in manual measurements, and a ruler 30 extendably positioned within. The user first utilizes the wheel member 40 to measure the length of the main beams, each tine length, and the circumference between each tine. The user then utilizes the ruler 30 to measure the inside spread between the main beams which is entered into the keypad 26. The central processing unit combines the total measurements to generate a final score based upon one or more antler scoring systems such as BOONE & CROCKET, SAFARI CLUB INTERNATIONAL, and BUCKMASTERS TROPHY RECORDS.

As shown in FIGS. 1 through 4 of the drawings, the housing 20 is preferably comprised of an elongate structure having a neck 28. It can be appreciated that the housing 20 may have various shapes, sizes, structures and designs wherein the housing 20 illustrated within the drawings is merely for illustration purposes only.

A central processing unit is contained within the housing 20. The central processing unit includes a general purpose digital processor which controls the operation of the central processing unit. The microprocessor can be a single-chip processor or implemented with multiple components. Using instructions retrieved from memory, microprocessor controls the reception and manipulations of input data and the output and display 22 of data on output devices such as the display 22.

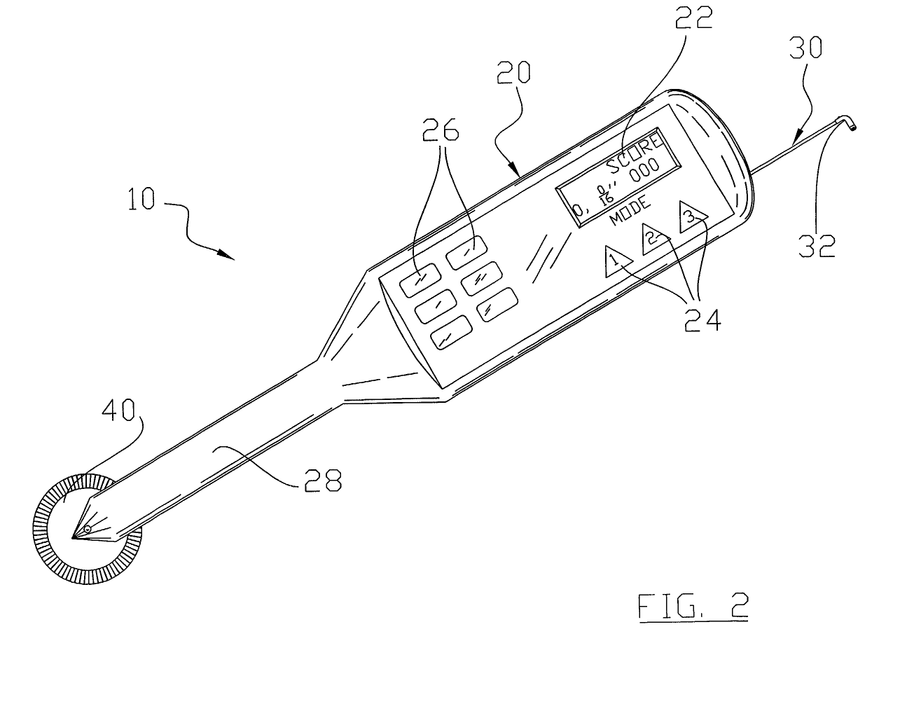

As shown in FIGS. 1 and 2 of the drawings, a display 22 is positioned within the housing 20 for displaying the measurements, mode, final score and various other items. The display 22 is in communication with the central processing unit via conventional communication means.

As further shown in FIGS. 1 and 2 of the drawings, a plurality of mode selectors 24 are preferably positioned within the housing 20 and in communication with the central processing unit. The mode selectors 24 allow the user to select the scoring system to be utilized to measure the antlers 12 such as but not limited to BOONE & CROCKET, SAFARI CLUB INTERNATIONAL, and BUCKMASTERS TROPHY RECORDS.

A keypad 26 is also provided within the housing 20 and in communication with the central processing unit for allowing the manual entry of measurements into the central processing unit. The keypad 26 may also allow for the adjustment of various items such as the format of the measurements (i.e. inches or centimeters).

As shown in FIGS. 1 through 4 of the drawings, the wheel member 40 is rotatably attached to a distal portion of the neck 28 of the housing 20. The wheel member 40 is able to rotate upon a surface such as the main beam of the antlers 12 to allow for the measurement of individual features such as the main beam length and the circumference of the main beam. The wheel member 40 is measured by a measuring device that is comprised of standard technology that communicates to the central processing unit the distance the wheel member 40 has traveled upon.

Examples of measuring devices currently within the marketplace of the SCALE MASTER CLASSIC manufactured by CALCULATED INDUSTRIES (www.calculated.com), and the PLANWHEEL manufactured by SCALEX CORPORATION (www.scalex.com). These products are considered relevant to the central processing unit, the measuring device and wheel member 40 of the present invention and are incorporated herein by reference. The aforementioned products, some of which are mentioned elsewhere in this disclosure, and which form a part of this disclosure, may be applied in known manner by those skilled in the art in order to practice various embodiments of the present invention.

As shown in FIGS. 1 through 4 of the drawings, a ruler 30 is positioned within the housing 20 that is extendible from within the housing 20. The ruler 30 may be comprised of any well known compact and extendible structure that are commonly utilized to construct conventional tape measures and the like. The ruler 30 preferably includes an engaging member 32 at the distal end thereof for usage in determining manual measurements.

In use, the user selects the mode by depressing one of the mode selectors 24 to place the central processing unit into the desired scoring mode such as BOONE & CROCKET, SAFARI CLUB INTERNATIONAL, and BUCKMASTERS TROPHY RECORDS. The user then selects a button upon the keypad 26 to indicate to the central processing unit which measurement is going to be taken such as the total lengths of abnormal points, the length of main beam, length of each individual point, circumference at smallest place between burr and first point, circumference at smallest place between each of the points and various other required measurements. The user then positions the wheel member 40 in the desired location upon the antlers 12 and moves the wheel member 40 to take the required measurement. When finished taking the measurement, the user then selects a button upon the keypad 26 to indicate that the measurement is completed. The central processing unit then stores the measurement as indicated by the user for calculating the final score. This process continues for each of the other measurements that may be taken with the wheel member 40. The user then utilizes the ruler 30 to measure the tip to tip spread, the greatest spread between the antlers 12 and the inside spread of the main beams. These measurements are manually entered into the central processing unit using the keypad 26 which are then stored by the central processing unit as indicated by the user. The user may also manually enter other measurements into the keypad 26 such as the number of points on the left and right antlers 12 and various other measurements. After all of the required measurements are taken, the central processing unit then calculates the final score based upon the selected scoring system equation (i.e. BOONE & CROCKET, SAFARI CLUB INTERNATIONAL, and BUCKMASTERS TROPHY RECORDS). The final score is then shown upon the display 22 for the user to view.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An antler scoring system, comprising:
a housing;
a central processing unit within said housing, wherein central processing unit is able to calculate a final score based upon measurements computed utilizing an antler scoring system;
a display within said housing and in communication with said central processing unit;
a keypad within said housing and in communication with said central processing unit for entering data into said central processing unit; and
a wheel measuring unit attached to said housing and in communication with said central processing unit for providing said measurements to said central processing unit.

2. The antler scoring system of claim 1, including a ruler positioned within said housing.

3. The antler scoring system of claim 2, wherein said ruler is extendible from said housing.

4. The antler scoring system of claim 3, wherein said ruler includes an engaging member.

5. The antler scoring system of claim 1, including a plurality of mode selectors within said housing and in communication with said central processing unit, wherein said plurality of mode selectors represent a specific antler scoring system.

6. The antler scoring system of claim 5, including a ruler positioned within said housing.

7. The antler scoring system of claim 1, wherein said housing has an elongate neck supporting said wheel measuring unit.

8. A method of scoring antlers utilizing a measuring unit having a housing, a central processing unit, a display, a keypad, a wheel measuring unit and a ruler, comprising the steps of:
(a) measuring a length of each main beam of said antlers with said wheel measuring unit;
(b) measuring a circumference between each tine of said antlers with said wheel measuring unit;
(c) measuring a length of each tine of said antlers with said wheel measuring unit;
(d) measuring a spread between each said main beam of said antlers with said ruler; and
(e) entering said spread into said keypad.

9. The method of scoring antlers of claim 8, including the step of computing a final score based upon a specific antler scoring system.

10. A method of scoring antlers utilizing a measuring unit having a housing, a central processing unit, a display, a keypad, a wheel measuring unit and a ruler, comprising the steps of:
(a) selecting an antler scoring system;
(b) measuring a length of each main beam of said antlers with said wheel measuring unit;
(c) measuring a circumference between each tine of said antlers with said wheel measuring unit;
(d) measuring a length of each tine of said antlers with said wheel measuring unit;
(e) measuring a spread between each said main beam of said antlers with said ruler; and
(f) entering said spread into said keypad.

11. The method of scoring antlers of claim 10, including the step of computing a final score based upon said antler scoring system.
